(19) United States
(12) Patent Application Publication
(10) Pub. No.: US 2025/0254277 A1
(43) Pub. Date: Aug. 7, 2025

(54) DISPLAY METHOD

(71) Applicant: SEIKO EPSON CORPORATION, Tokyo (JP)

(72) Inventors: Kana HATANO, Matsumoto-shi (JP); Taku NAKAMURA, Ina-shi (JP); Soma TODA, Matsumoto-shi (JP)

(73) Assignee: SEIKO EPSON CORPORATION, Tokyo (JP)

(21) Appl. No.: 19/042,910

(22) Filed: Jan. 31, 2025

(30) Foreign Application Priority Data
Feb. 2, 2024 (JP) 2024-014728

(51) Int. Cl. H04N 9/31; G06F 3/16

(52) U.S. Cl. CPC H04N 9/3179; G06F 3/167

(57) ABSTRACT

A video generator includes a first acquisition unit, a second acquisition unit, a third acquisition unit, a fourth acquisition unit, a generation unit, and a display control unit. The first acquisition unit acquires a captured image by capturing a white image projected onto a projection region. The second acquisition unit acquires environment information concerning an environment in which a projection target object is placed. The third acquisition unit acquires physical information based on the captured image. The fourth acquisition unit acquires user input information representing an instruction of a user. The generation unit generates an image of content based on the physical information, the environment information, the user input information, and a learning model file. The display control unit causes a projector to project the image of the content.

The present application is based on, and claims priority from JP Application Serial Number 2024-014728, filed Feb. 2, 2024, the disclosure of which is hereby incorporated by reference herein in its entirety.

### BACKGROUND

### 1. Technical Field

The present disclosure relates to a display method.

### 2. Related Art

JP-A-2012-84001 discloses that a projection image is generated by combining an input image with a predetermined background image. JP-A-2012-84001 discloses that the background image is prepared in advance or generated in a background video generation unit 33 based on a signal of the input image.

JP-A-2012-84001 is an example of the related art.

In JP-A-2012-84001, a projection image is generated by combining an input image with the predetermined background image. However, an image of content projected onto a projection target object cannot be combined based on information concerning an environment in which the projection target object is placed, the information being not obtained from a captured image of the projection target object.

### SUMMARY

An aspect of a display method of the present disclosure includes: acquiring a captured image by imaging a projection region; acquiring environment information that is information concerning an environment in which a projection target object is placed; acquiring physical information based on the captured image; generating a first projection image based on the physical information and the environment information; and displaying the first projection image.

### BRIEF DESCRIPTION OF THE DRAWINGS

FIG. 1 is a diagram illustrating a configuration example of a system 1 according to an embodiment of the present disclosure.

FIG. 2 is a diagram illustrating a configuration example of a video generator 20 provided in the system 1.

FIG. 3 is a diagram illustrating an example of an image of content generated by the video generator 20.

FIG. 4 is a diagram illustrating an example of an image of content generated by the video generator 20.

FIG. 5 is a flowchart illustrating a flow of processing in a display method executed by a processing device 210 of the video generator 20 according to a program PRA.

### DESCRIPTION OF EMBODIMENTS

Various technically preferable limitations are applied to an embodiment explained below. However, embodiments of the present disclosure are not limited to the embodiment explained below.

### 1. Embodiment

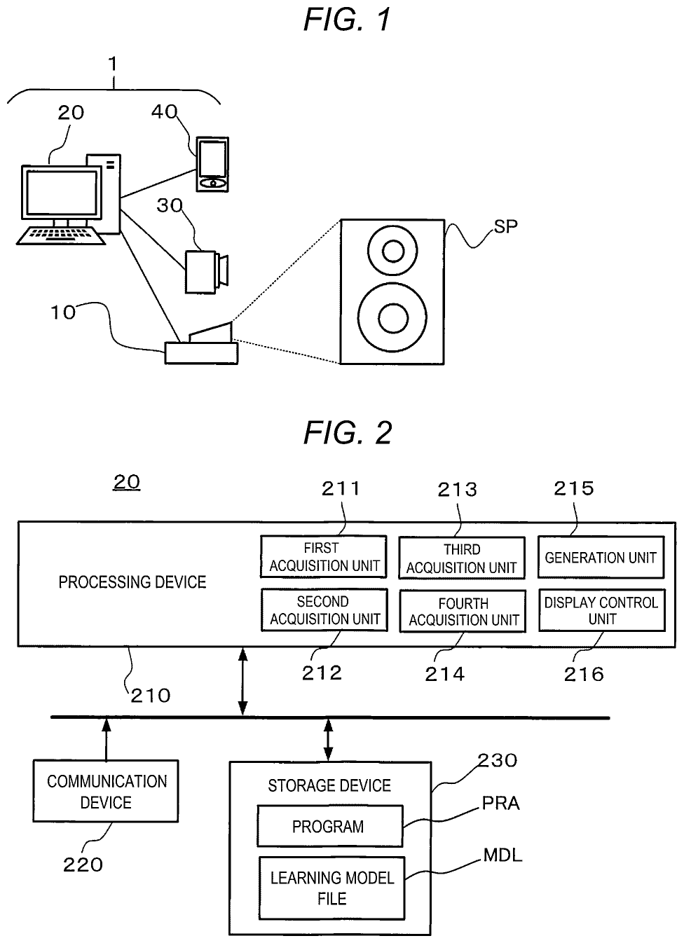

FIG. 1 is a diagram illustrating a configuration example of a system 1 according to an embodiment of the present disclosure. The system 1 is a system that implements projection mapping by projecting an image onto a projection target object. As illustrated in FIG. 1, the system 1 includes a projector 10, a video generator 20, an imaging device 30, and a user terminal 40. Each of the projector 10, the imaging device 30, and the user terminal 40 is connected to the video generator 20 by radio or wire.

The projector 10 implements projection mapping by projecting an image represented by image data supplied from the video generator 20 onto a projection target object. That is, in the present embodiment, the surface of the projection target object is a projection region. The projection target object according to the present embodiment is, for example, a speaker SP installed in a living room of a house of a user but may be a building or the like. The imaging device 30 is, for example, a video camera. The imaging device 30 is disposed at a position and a posture in which the projection region of the projection target object falls within an imaging visual field. The imaging device 30 images the projection target object under the control of the video generator 20. The imaging device 30 supplies image data representing a captured image obtained by imaging the projection target object to the video generator 20.

The user terminal 40 is, for example, a smartphone. The user terminal 40 receives operation of a user using the system 1 and transmits user input information corresponding to the operation to the video generator 20. The user input information in the present embodiment represents a character string (for example, bright or traditional) in which an instruction of the user concerning content to be projected onto a projection target object is written. The character string in which the instruction of the user concerning the content to be projected onto the projection target object is written is an example of the first language data in the present disclosure. An intention of the user concerning the content to be projected onto the projection target object is reflected on the user input information. The user input information is transmitted from the user terminal 40 to the video generator 20, whereby the intention of the user concerning the content to be projected onto the projection target object is conveyed to the video generator 20.

The video generator 20 is, for example, a personal computer. The video generator 20 generates projection image data representing a projection image to be projected on a projection target object from the projector 10 based on captured image data supplied from the imaging device 30 and environment information given from the user terminal 40. The environment information in the present embodiment is sound information representing sound around the projection target object. When the user terminal 40 includes a microphone, the user collects sound around the projection target object using the microphone and uses sound information representing the sound as environment information. In the present embodiment, the microphone provided in the user terminal 40 is used as a sensor for collecting environment information. However, the sensor may be provided in the system 1 separately from the user terminal 40. The environment information is not limited to the sound information representing the sound around the projection target object and may be information representing a light amount of external light around the projection target object, information representing temperature, smell, or pressure around the projection target object, information representing a vibration amount of a space in which the projection target object is installed, information representing the depth of the space in which the projection target object is installed, information representing emotion, a body temperature, or a behavior of a person present around the projection target object, or the like. A suitable sensor only has to be used according to a type of the environment information.

FIG. 2 is a diagram illustrating a configuration example of the video generator 20. As illustrated in FIG. 2, the video generator 20 includes a processing device 210, a communication device 220, and a storage device 230. The processing device 210 is one or more processors. The processing device 210 is, for example, a central processing unit (CPU). The processing device 210 operates according to a program PRA stored in the storage device 230 to thereby function as a control center of the video generator 20. The communication device 220 is a device that performs wireless communication or wired communication with other devices and includes, for example, an interface circuit. Specific examples of the other devices that communicate with the communication device 220 include the projector 10, the imaging device 30, and the user terminal 40.

The storage device 230 is a recording medium readable by the processing device 210. The storage device 230 includes, for example, a nonvolatile memory and a volatile memory. The nonvolatile memory is, for example, a read only memory (ROM), an erasable programmable read only memory (EPROM), or an electrically erasable programmable read only memory (EEPROM). The volatile memory is, for example, a random access memory (RAM). The nonvolatile memory of the storage device 230 stores various programs and a learning model file MDL.

The learning model file MDL is data corresponding to an inference model that has learned a correspondence relationship between an image generation condition (prompt or high paper parameter) and an image generated according to the generation condition. A well-known technique only has to be adopted as appropriate for the learning model file MDL. In the present embodiment, the processing device 210 uses the learning model file MDL to thereby perform a comprehensive data analysis based on information input from a plurality of modalities (formats) such as an image, a sound, and a language and function as an image generation AI for generating an image.

Examples of the various programs stored in the nonvolatile memory include a kernel program and the program PRA. In FIG. 2, illustration of the kernel program is omitted. The kernel program is a program for causing the processing device 210 to implement an operating system (OS).

The processing device 210 reads the kernel program from the nonvolatile memory to the volatile memory at the opportunity when the video generator 20 is turned on and starts executing the read kernel program. The processing device 210 operating according to the kernel program starts executing another program triggered at the opportunity when an execution start of the other program is instructed by operation represented by operation content data received from the user terminal 40 via the communication device 220. For example, when an execution start of the program PRA is instructed, the processing device 210 reads the program PRA from the nonvolatile memory to the volatile memory and starts executing the program PRA read to the volatile memory.

The processing device 210 operating according to the program PRA functions as a first acquisition unit 211, a second acquisition unit 212, a third acquisition unit 213, a fourth acquisition unit 214, a generation unit 215, and a display control unit 216 illustrated in FIG. 2. That is, each of the first acquisition unit 211, the second acquisition unit 212, the third acquisition unit 213, the fourth acquisition unit 214, the generation unit 215, and the display control unit 216 illustrated in FIG. 2 is a software module implemented by causing the processing device 210 to operate according to the program PRA. A role of each of the first acquisition unit 211, the second acquisition unit 212, the third acquisition unit 213, the fourth acquisition unit 214, the generation unit 215, and the display control unit 216 illustrated in FIG. 2 is as explained below.

The first acquisition unit 211 controls the projector 10 to thereby, for example, cause the projector 10 to project an image of a white color (a second projection image) onto a projection target object and controls the imaging device 30 to thereby capture the image projected onto a projection region and acquire captured image data representing the captured image. When the projection region is designated by the user, the first acquisition unit 211 may control the imaging device 30 to thereby image the projection region where the image is not projected and acquire captured image data representing the captured image.

The second acquisition unit 212 communicates with the user terminal 40 to thereby acquire environment information that is information not acquired in imaging by the imaging device 30 in information concerning an environment in which the projection target object is placed.

The third acquisition unit 213 acquires physical information based on the captured image represented by the captured image data acquired by the first acquisition unit 211. The physical information is information representing a space in which the projection target object is installed or at least one of a shape, a color, and a reflection characteristic of the projection target object. Specific examples of the information indicating the color the reflection characteristic include RGB values and luminance of a region corresponding to the projection target object in the captured image.

The fourth acquisition unit 214 acquires user input information by communicating with the user terminal 40. As explained above, the user input information in the present embodiment represents the character string in which the instruction of the user concerning the content to be projected onto the projection target object is written. However, the user input information may represent voice of reading the instruction or may be an image drawn by the user of a musical piece played or sung by the user. In short, the user input information only has to be data reflecting the intention of the user concerning the content to be projected onto the projection target object.

The generation unit 215 generates, based on the physical information, the environment information, the user input information, and the learning model file MDL, content data representing an image (a first projection image) of the content to be projected on the projection target object from the projector 10. More specifically, first, the generation unit 215 aligns an amount of information through filtering or the like such that each of the physical information, the environment information, and the user input information can be equally treated and generates a generation condition of the content data. The generation condition includes a weight representing the strength of influence of each of the physical information, the environment information, and the user input information on the content data. Then, the generation unit 215 inputs the generation condition to the learning model file MDL to generate content data representing content corresponding to the generation condition.

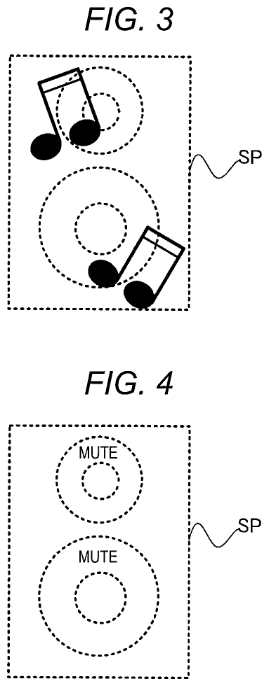

For example, it is assumed that the projection target object is the speaker SP illustrated in FIGS. 3 and 4 and whether sound is output from the speaker SP is represented by the environment information. In this case, the generation unit 215 recognizes, based on the appearance or the like of the projection target object represented by the physical information, that the projection target object is the speaker SP and, when the environment information represents that sound is output from the speaker SP, as illustrated in FIG. 3, generates, as an image of the content, an image representing musical notes arranged on the surface of the speaker SP. In contrast, when the environment information represents that no sound is output from the speaker SP, as illustrated in FIG. 4, the generation unit 215 generates, as an image of the content, an image representing a character string “mute” arranged on the surface of the speaker SP. The user input information is reflected on a color and a shape of the musical notes, etc., or the character string “mute”. For example, when the user input information is reflected on the color of the musical notes or the like, the generation unit 215 generates, when “vivid” is instructed, an image in which the musical notes or the like are drawn in red and generates, when “traditional” is designated, an image in which the musical notes or the like are drawn in a blue black color.

The display control unit 216 transmits the content data generated by the generation unit 215 to the projector 10 and causes the projector 10 to project an image represented by the content data to thereby display the image.

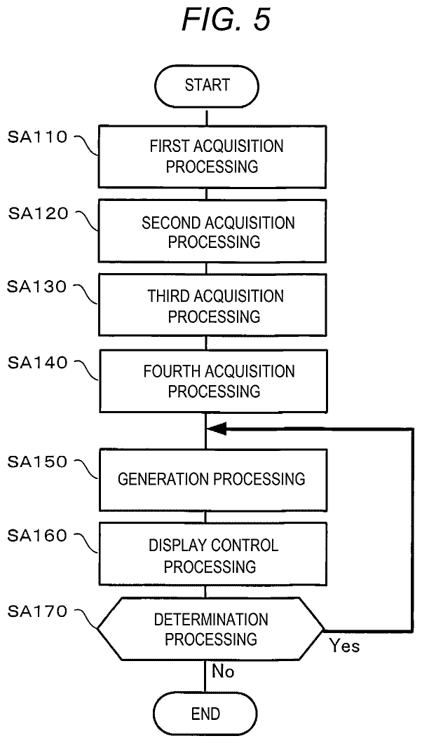

The processing device 210 operating according to the program PRA executes a display method markedly indicating the characteristics of the present disclosure. FIG. 5 is a flowchart illustrating a flow of processing in this display method. As illustrated in FIG. 5, the display method includes first acquisition processing SA110, second acquisition processing SA120, third acquisition processing SA130, fourth acquisition processing SA140, generation processing SA150, display control processing SA160, and determination processing SA170.

In the first acquisition processing SA110, the processing device 210 functions as the first acquisition unit 211. In the first acquisition processing SA110, the processing device 210 controls the projector 10 to thereby cause the projector 10 to project a second projection image onto a projection target object and controls the imaging device 30 to thereby capture the image projected onto a projection region and acquires captured image data representing the captured image.

In the second acquisition processing SA120 following the first acquisition processing SA110, the processing device 210 functions as the second acquisition unit 212. In the second acquisition processing SA120, the processing device 210 acquires environment information. The second acquisition processing SA120 may be executed prior to the first acquisition processing SA110 or may be executed after execution of the third acquisition processing SA130 or the fourth acquisition processing SA140 explained below.

In the third acquisition processing SA130 following the second acquisition processing SA120, the processing device 210 functions as the third acquisition unit 213. In the third acquisition processing SA130, the processing device 210 acquires physical information based on the captured image represented by the captured image data acquired in the first acquisition processing SA110.

In the fourth acquisition processing SA140 following the third acquisition processing SA130, the processing device 210 functions as the fourth acquisition unit 214. In the fourth acquisition processing SA140, the processing device 210 acquires user input information by communicating with the user terminal 40. The fourth acquisition processing SA140 may be executed prior to any one or a plurality of the first acquisition processing SA110, the second acquisition processing SA120, and the third acquisition processing SA130. In short, the first acquisition processing SA110, the second acquisition processing SA120, the third acquisition processing SA130, and the fourth acquisition processing SA140 only have to have been executed at a point in time of an execution start of the generation processing SA150 explained below.

In the generation processing SA150, the processing device 210 functions as the generation unit 215. In the generation processing SA150, the processing device 210 generates, based on the physical information, the environment information, the user input information, and the learning model file MDL, content data representing an image of content to be projected onto the projection target object from the projector 10. In the display control processing SA160 following the generation processing SA150, the processing device 210 functions as the display control unit 216. In the display control processing SA160, the processing device 210 transmits the content data generated in the generation processing SA150 to the projector 10 and causes the projector 10 to project an image represented by the content data to thereby display the image. The user can check a degree of matching between the image of the content and the shape of the projection target object by visually checking the image of the content projected onto the projection target object by the projector 10. When the user is dissatisfied with the degree of matching, the user can instruct regeneration of content data by operating the user terminal 40. When instructing regeneration of content data, in order to improve the degree of matching between the image of the content and the shape of the projection target object, the user edits the generation condition, for example, increases the weight of the physical information included in the generation condition.

In the determination processing SA170 following the display control processing SA160, the processing device 210 determines whether regeneration of content data has been instructed by the user. When regeneration of content data has been instructed by the user, a determination result of the determination processing SA170 is “Yes”. When the determination result of the determination processing SA170 is “Yes”, the processing device 210 executes the generation processing SA150 and the subsequent processing again. In the generation processing SA150 executed again, content data is generated by the user using the edited generation condition. In contrast, when regeneration of content data has not been instructed by the user, the determination result of the determination processing SA170 is “NO”. When the determination result of the determination processing SA170 is “No”, the processing device 210 ends the display method. Specific examples of the user not instructing regeneration of content data include the user not being dissatisfied with the degree of matching between the image of the content and the shape of the projection target object.

As explained above, according to the present embodiment, it is possible to automatically perform two steps, for implementing projection mapping, of generating content and adjusting the generated content to a projection image having a high degree of matching with the shape of the projection target object. In the present embodiment, since the content is generated based on the physical information and the environment information, it is possible to generate content reflecting sound and the like around the projection target object. According to the present embodiment, in the step of generating content, the user can perform fixed instruction and can generate content including details corresponding to the instruction. The instruction of the user does not need to take a form of a programming language or an image and can take a wide range of forms such as text input and voice input.

### 2. Other Embodiments

(1) In the embodiment explained above, when dissatisfied with the degree of matching of the video with the shape of the projection target object, the user improved the degree of the matching of the video with the shape of the projection target object by increasing the weight of the physical information used at the time of image generation and repeating the change of the weight and the output until the video matches the preference. However, it is also possible to improve the degree of matching of the video with the shape of the projection target object by performing feature point extraction on the captured image of the projection target object and using a result of the feature point extraction together with the physical information and the environment information. In order to output a video that more closely matches the preference, the user may correct and modify the first language data.

(2) In the generation of an image using the generation AI, an image as expected by the user is not always generated. Even if a generation condition is edited, the image is not always improved. Therefore, the video generator 20 may store all of generation conditions and generation results, visualize the generation conditions and the generation results to be visually easily seen like a flowchart, and display the visualized generation conditions and generation results on the user terminal 40. The user can generate content data by returning to a preferred condition in the flowchart.

### 3. Modifications

The embodiments explained above can be modified as follows.

(1) The generation unit 215 may generate voice data based on the physical information and the environment information in addition to the content data. The display control unit 216 may display a content image and output voice represented by the voice data generated by the generation unit 215. According to this aspect, it is possible to provide not only an image but also voice to the user as content matching a space in which an image is projected.

(2) The instruction of the user represented by the first language data does not need to be complete and may have deficiency. When the instruction of the user represented by the first language data has deficiency, the generation unit 215 only has to complement the deficiency with reference to past input of the user or dataset, etc., prepared in advance to generate second language data and generate an image of the content using the second language data, the physical information, and the environment information. Specific examples of the past input of the user or the dataset prepared in advance include information representing an instruction or an intention of the user input when video content was generated in the past.

(3) The first acquisition unit 211, the second acquisition unit 212, the third acquisition unit 213, the fourth acquisition unit 214, the generation unit 215, and the display control unit 216 in the embodiment explained above are software modules. However, any one, any two, any three, any four, or all of the first acquisition unit 211, the second acquisition unit 212, the third acquisition unit 213, the fourth acquisition unit 214, the generation unit 215, and the display control unit 216 may be hardware modules such as an application specific integrated circuit (ASIC). Even if at least one of the first acquisition unit 211, the second acquisition unit 212, the third acquisition unit 213, the fourth acquisition unit 214, the generation unit 215, and the display control unit 216 is a hardware module, the same effects as the effects of the embodiment explained above are achieved. The fourth acquisition unit 214 is not always essential and may be omitted. In an aspect in which the fourth acquisition unit 214 is omitted, the generation unit 215 only has to generate content data based on the physical information and the environment information.

(4) The program PRA may be manufactured alone and may be provided for payment or free of charge. Specific aspects at the time of providing the program PRA include an aspect in which the program PRA is written in a computer-readable recording medium such as a flash ROM and provided and an aspect in which the program PRA is provided by being downloaded through an electric communication line such as the Internet. By causing a general computer to operate according to the program PRA provided by these aspects, it is possible to cause the computer to execute the display method of the present disclosure. In the embodiment explained above, the user terminal 40 and the video generator 20 are the separate devices. However, the user terminal 40 may be provided in the video generator 20. The imaging device 30 may be provided in any one of the projector 10, the video generator 20, and the user terminal 40.

### 4. Summary of the Present Disclosure

The present disclosure is not limited to the embodiment and the modifications explained above and can be implemented in various aspects without departing from the gist of the present disclosure. For example, the present disclosure can also be implemented by the following aspects. In order to solve a part or all of the problems of the present disclosure or to achieve a part or all of the effects of the present disclosure, the technical features in the embodiment explained above corresponding to the technical features in aspects explained below can be replaced or combined as appropriate. The technical f features can be deleted as appropriate unless the technical features are explained as essential technical features in the present specification.

The present disclosure is summarized below as appendices.

### Appendix 1

A display method of the present disclosure includes: acquiring a captured image by imaging a projection region; acquiring environment information that is information concerning an environment in which a projection target object is placed; acquiring physical information based on the captured image; generating a first projection image based on the physical information and the environment information; and displaying the first projection image. With the display method in this aspect, since the first projection image is generated based on the physical information and the environment information, a user can easily project an image relating to content.

### Appendix 2

In a display method in a more preferred aspect, in the display method described in (Appendix 1), the generating the first projection image based on the physical information and the environment information may include generating the first projection image based on the physical information, the environment information, and a learning model file. With the display method in this aspect, since the first projection image is generated based on the physical information, the environment information, and the learning model file, the user can easily project the image relating to the content.

### Appendix 3

A display method in a still more preferred aspect may further include: in the display method described in (Appendix 1) or (Appendix 2), generating voice data based on the physical information and the environment information; and displaying the first projection image and outputting voice represented by the voice data. According to this aspect, it is possible to provide not only an image but also voice to the user as content matching a space in which an image is projected.

### Appendix 4

A display method in another preferred aspect may further include, in the display method described in (Appendix 1), (Appendix 2), or (Appendix 3), acquiring first language data, and the generating the first projection image based on the physical information and the environment information may include generating the first projection image based on the physical information, the environment information, and the first language data. With the display method in this aspect, a smart speaker or the like can reflect an instruction or a request received from the user on the content.

### Appendix 5

A display method in another preferred aspect may further include, in the display method described in (Appendix 4), complementing the first language data based on a dataset to generate second language data, and the generating the first projection image based on the first language data may include generating the first projection image based on the second language data. According to this aspect, when an instruction received from the user is ambiguous, the instruction can be clarified.

1. A display method comprising:
acquiring a captured image by imaging a projection region;
acquiring environment information that is information concerning an environment in which a projection target object is placed;
acquiring physical information based on the captured image;
generating a first projection image based on the physical information and the environment information; and
displaying the first projection image.

2. The display method according to claim 1, wherein the generating the first projection image based on the physical information and the environment information includes generating the first projection image based on the physical information, the environment information, and a learning model file.

3. The display method according to claim 1, further comprising:
generating voice data based on the physical information and the environment information; and
displaying the first projection image and outputting voice represented by the voice data.

4. The display method according to claim 1, further comprising acquiring first language data, wherein
the generating the first projection image based on the physical information and the environment information includes generating the first projection image based on the physical information, the environment information, and the first language data.

5. The display method according to claim 4, further comprising complementing the first language data based on a dataset to generate second language data, wherein
the generating the first projection image based on the first language data includes generating the first projection image based on the second language data.

6. The display method according to claim 2, further comprising acquiring first language data, wherein
the generating the first projection image based on the physical information and the environment information includes generating the first projection image based on the physical information, the environment information, and the first language data.

7. The display method according to claim 3, further comprising acquiring first language data, wherein
the generating the first projection image based on the physical information and the environment information includes generating the first projection image based on the physical information, the environment information, and the first language data.
